(19) United States
(12) Patent Application Publication
(10) Pub. No.: US 2011/0122437 A1
(43) Pub. Date: May 26, 2011

(54) SERVER, PRINT SYSTEM, IMAGE FORMING APPARATUS, AND RECORDING MEDIUM

(75) Inventor: Yoshihiko SHIMOHIRA, Kanagawa (JP)

(73) Assignee: RICOH COMPANY, LTD.

(21) Appl. No.: 12/941,200

(22) Filed: Nov. 8, 2010

(30) Foreign Application Priority Data
Nov. 20, 2009 (JP) 2009-264593

(51) Int. Cl. G06F 15/00

(52) U.S. Cl. 358/1.15

(57) ABSTRACT

A disclosed server connected to one or more clients via a network, includes a response unit responding as an image forming apparatus to a device searching message sent from the client; an associating information control unit associating the client with the image forming apparatus; a storing unit storing driver generation information which enables generation of a driver corresponding to the image forming apparatus on a side of the client; a driver generation controlling unit responding to a driver generation information acquiring request from the client and sending the driver generation information to the client; and a print control unit responding to a print request received from the driver and sending print data corresponding to the print request to the image forming apparatus in response to the print request received from the driver generated by the client and causing the print data to be printed with the image forming apparatus.

### BACKGROUND OF THE INVENTION

1. Field of the Invention

The present invention generally relates to a printer driver, and more specifically, to a server, a print system managing the printer driver, the print system including the server, an image forming apparatus receiving a print command from the printer driver provided by the server, and a recording medium storing a program causing a computer to function as the server.

2. Description of the Related Art

There are examples of techniques proposed to reduce working load and administrative burden in installing printer drivers. For example, printer drivers are simultaneously managed by a print server in an environment of Windows (Windows is a registered trademark). All necessary files and configuration information are downloaded from the printer server. This technique of installing the printer drivers is called “point and print”.

Further, in Vista (Vista is a registered trademark) of Windows (Windows is the registered trademark), when a device compliant with a WSD (Web Services on Devices) protocol is connected to a network, the client device automatically recognizes the existence of the device and displays an icon corresponding to the device on a network folder to thereby facilitate installation of a driver for the device and setup of a port for the device. With this technique, the user opens a network folder on an explorer (browser), puts a pointer on the icon of an arbitrary printer among the automatically recognized icons, and selects an item to be installed from a menu displayed by clicking a right button of a mouse. Thus, work burden on a user in installing and uninstalling the printer driver is relaxed.

However, in the above installing method using the WSD protocol, it is possible to install only a driver compliant with the WSD protocol previously held by a client device. A driver which is not installed in the client device may be installed from another medium or a package may be previously obtained via a network. A printer driver in compliance with many types of printers is developed on a developer side of developing the printer driver in order to relax increments of the work burden on the user caused by a difference of types of printers. However, a large amount of labor is necessary to develop such a printer driver. Therefore, the printer drivers are generally provided for respective types of the printers.

On the other hand, there is an example technique of reducing driver development costs. Capability information describing information about performance or the like is acquired from a printer, and a driver is generated in a client device in accordance with the capability information as in Patent Document 1. By applying the technique and dynamically generating a driver for the client device from information acquired from the printer, it basically becomes unnecessary to develop drivers type by type.

Patent Document 2 discloses an installing server related to the above WSD protocol. When an image forming apparatus which is not in compliance with the WSD print service is connected to an installing server, a WSD print service may be provided to the image forming apparatus. A record including identification information, positional information and driver identification information of the image forming apparatus is registered. When a device information acquiring request is received from a client device, the identification information and the driver identification information included in the record are returned and print data to which the identification information is added are received from the client device. A record including identification information matching the identification information added to the print data received from the client device is searched. The print data are sent to the image forming apparatus having positional information included in the searched record.

With the above technique, it is possible to relax the work burden in installing the printer driver to a certain extent. However, (1) a package of drivers of prospective types is held by the client device in advance, and (2) when plural printers are usable, a desired printer is searched for from the plural printers displayed using icons in a network folder. Further, in the above technique, (3) when the printer used by the user becomes unusable, a printer driver for a substitute printer is newly installed. Therefore, the work burden of the installation and administrative burden of the installation are not desirable. Further, in the view of an administrator of the print system, (4) when various functions are provided in the printer, a usable function may be limited for each user.

In the above technique described in Patent Document 2, the WSD print service is enabled to be used in a printer which is not in conformity with the WSD. However, the technique of Patent Document 2 does not solve the above items (1) to (3) nor satisfy the above item (4). The technique disclosed in Patent Document I aims to reduce labor in developing a printer driver, and the work burden and the administrative burden are not reduced by the technique.

Therefore, there exists a preference for a technique of not acquiring a driver for a printer which does not conform to the WSD protocol in advance, of being free from searching for a printer to be used out of a list, and of being enabled to install a driver in the client device with a simple operation. Further, there is a preference for a technique which removes corresponding work for a user and an administrator even if an environment for the usage is changed to disable use of the printer in use. Further, there is a preference for a technique with which an administrator may flexibly limit the use of a printer function for each user.

Patent Document 1: Japanese Laid-Open Patent Application No. 2009-181573

Patent Document 2: Japanese Laid-Open Patent Application No. 2009-15408

### SUMMARY OF THE INVENTION

Accordingly, in consideration of the above example techniques, embodiments of the present invention may provide a novel and useful server, which can reduce a burden of installing various printer drivers corresponding to types into client devices as much as possible even under an environment in which various image forming apparatuses exist which conform to or do not conform to a predetermined device recognition protocol and enables effective administration of uses of the image forming apparatus by an administrator; a printing system including the server; an image forming apparatus which receives a print command from a printer driver provided by the server and prints; and a recording medium storing a program causing a computer to function as the server.

One aspect of the embodiments of the present invention may be to provide a server connected to one or more client devices via a network, including a response unit configured to respond as an image forming apparatus to a device searching message sent from the one or more client devices; an associating information control unit configured to associate the one or more client devices with the image forming apparatus; a storing unit configured to store driver generation information which enables generation of a driver corresponding to the image forming apparatus on a side of the one or more client devices; a driver generation controlling unit configured to respond to a driver generation information acquiring request from the one or more client devices and send the driver generation information corresponding to the image forming apparatus associated with the one or more client devices to the one or more client devices; and a print control unit configured to respond to a print request received from the driver generated by the one or more client devices and send print data corresponding to the print request to the image forming apparatus associated with the one or more client devices in response to the print request received from the driver generated by the one or more client devices and cause the print data to be printed with the image forming apparatus.

Additional objects and advantages of the embodiments will be set forth in part in the description which follows, and in part will be clear from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

### BRIEF DESCRIPTION OF THE DRAWINGS

FIG. 1 is a schematic view of a network printing system of a First Embodiment.

FIG. 2 is a functional block diagram of the network printing system on a side of a server of the First Embodiment.

FIG. 3 is a functional block diagram of the network printing system on a side of a client device of the First Embodiment.

FIG. 4A illustrates an associating table which associates clients with output destinations.

FIG. 4B illustrates a data structure of a printer list.

FIG. 5 illustrates an example data structure of driver generation information for each type which is stored in a driver generation information storing unit of the server of the First Embodiment.

FIG. 6 is a sequence diagram for illustrating an installation process of a type-dependent driver into the network printing system of the First Embodiment.

FIG. 7 is a sequence diagram for illustrating a print process using the type-dependent driver in the network printing system of the First Embodiment.

FIG. 8 is a sequence diagram for illustrating an update process of the type-dependent driver in the network printing system of the First Embodiment.

FIG. 9 illustrates a graphical user interface displayed on a display of a client device.

FIG. 10 schematically illustrates a network printing system of a Second Embodiment.

FIG. 11A illustrates a data structure of a group managing table.

FIG. 11B illustrates a data structure of a function limitation managing table.

### DETAILED DESCRIPTION OF THE PREFERRED EMBODIMENTS

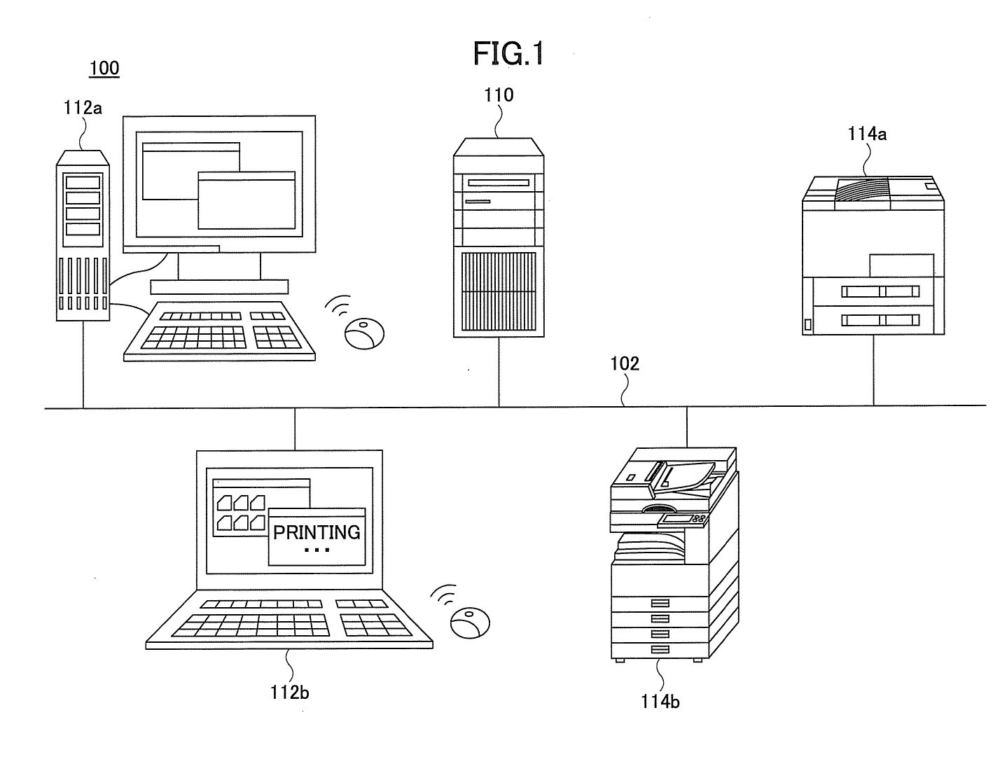

A description is given below, with reference to the FIG. 1 through FIG. 11B of the Embodiments of the present invention.

Reference symbols typically designate as follows:
100: Network printing system;
102: Network;
110: Server;
112: Client device;
114: Image forming apparatus;
200: Functional block diagram;
210: Section;
212: Network control unit;
214: Request control unit;
216: Type-dependent driver generation controlling unit;
218: Driver generation information reading unit;
220: Association information controlling unit;
222: Print control unit;
224: Format conversion unit;
226: Printer list searching unit;
228: Response unit;
230: Driver generation information storing unit;
232: Associating information storing unit;
234: Printer list storing unit;
240: Function limiting unit;
242: Charge processing unit;
244: Print setup changing unit;
246: Print data accumulating unit;
250: Functional block diagram;
260: Section;
262: Network control unit;
264: WSD protocol control unit;
270A: Common format driver;
270B: Type-dependent driver;
272: Type-dependent driver generating unit;
274: Install control unit;
276: Port generation control unit;
280: Driver data storing unit;
282: Port data storing unit;
300: Associating table;
310: Printer list;
320: Driver generation information;
330: Group managing table;
340: Function limitation managing table;
400: Screen;
402: Icon;
404: Pointer; and
406: Menu.

Hereinafter, a description of the embodiments is given. However, the present invention is not limited to the following embodiments. In the following embodiments, a network printing system including a server, a client device, and an image forming apparatus which are mutually connected via a network is described as an example of a print system including a server and a client device.

### First Embodiment

FIG. 1 schematically illustrates a network printing system 100 of the First Embodiment.

The network printing system 100 includes an on-demand print server (hereinafter, referred to as server) 110, a desktop computer 112a, a laptop computer 112b, a laser printer 114a, and a multifunction peripheral 114b (MFP), which are mutually connected by a network 102. Hereinafter, the desktop computer 112a and the laptop computer 112b are generally referred to as client devices, and the laser printer 114a and the MFP 114b are generally referred to as image forming apparatuses.

The above network 102 may be formed as a local area network (LAN), a virtual private network (VPN), a wide area network (WAN), or the like using Ethernet (Ethernet is a registered trademark), transmission control protocol/Internet protocol (TCP/IP), or the like. However, the structure of the network 102 is not specifically limited and may include the Internet connected via a router (not illustrated) or be a wired, wireless or wired and wireless mixed network. Further, a network connecting the server 110, the client devices 112, and the image forming apparatuses 114 may not be unitary. For example, the server 110 may be connected to the laser printer 114a by a network including a wired or wireless universal serial bus (USB).

The laser printer 114a and the MFP 114b each has a printer function and may be the image forming apparatus 114 of the First Embodiment. The image forming apparatus 114 may respond to a protocol such as Web Service on Device (WSD) or may not respond to the protocol. The WSD protocol is exemplified as a protocol for recognizing a device with a network extension plug and play capability. However, the First Embodiment is not limited the WSD protocol. A print request from the client device 112 may be directly sent to the image forming apparatus. In the First Embodiment, the print request is sent to the image forming apparatus 114 via the server 110.

The client device 112 carries out a multicast of a device searching message (Probe message) to the network 102 in order to search for a device conforming to the WSD which already exists on the network 102 after starting up the client device 112. The server 110 acts like a printer by responding to a device searching message from the client device 112 as the printer.

The server 110 holds associating information which associates the client device 112 with the image forming apparatus 114. The server 110 receives an acquiring request for information used for installing a printer driver peculiar to the type of the image forming apparatus 114 from the client device 112. The client device 112 specifies an output destination associated with the client device 112, and sends driver generation information for configuring the printer driver corresponding to the type of the image forming apparatus 114 positioned at the specified output destination. With this, an installation process in conformity with the driver generation information is carried out by the client device 112.

The driver generation information describes a function installed in the image forming apparatus, and is also referred to as capability information. The driver generation information is described in detail later. In the client device 112, the printer driver peculiar to the type of the image forming apparatus (hereinafter, referred to as type-dependent driver) is generated and installed. The printer driver conforming to a function of the corresponding output destination is dynamically configured to thereby display an appropriated user interface. However, the print request is not directly sent to the image forming apparatus 114. The print request affects the corresponding image forming apparatus 114 via the server 110 which acts like the printer.

When the print request is sent to the server 110 from the client device 112, print data corresponding to the print request are sent to the server 110. The server 110 receives the print data from the client device 112, and specifies the image forming apparatus 114 on the output destination which is associated with the client device 112 on the requestor side.

As described, by designating the printer driver of the server 110 and requesting to print in the client device 112, print data requested to be printed are sent to the image forming apparatus 114 at the corresponding output destination via the server 110. The association between the client device 112 and the image forming apparatus 114 is described in detail later. The administrator may carry out the association in conformity with the association table or dynamically carry it out in conformity with a previously defined rule which conditions the association.

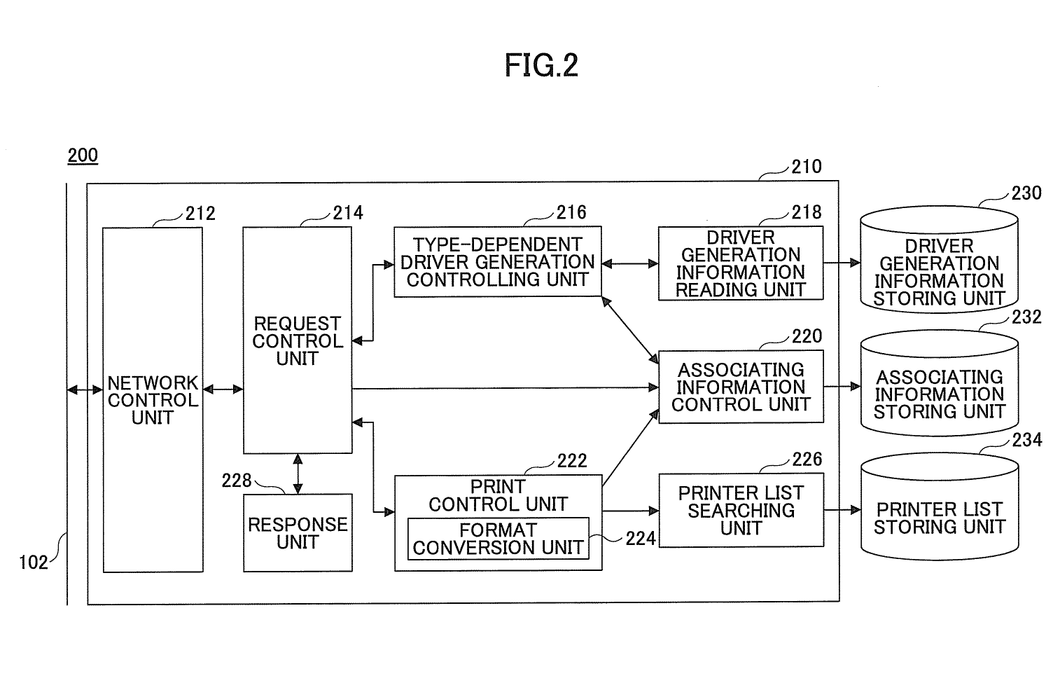

Next, the functional structure of the server 110 is described. FIG. 2 is a functional block diagram of a network printing system on the side of the server 110 of the First Embodiment. The functional block 200 on the side of the server 110 includes a network control unit 212, a request control unit 214, a type-dependent driver generation controlling unit 216, an associating information control unit 220, a print control unit 222, and a response unit 228.

Various functional units surrounded by a section 210 in FIG. 2 read out a program stored in a memory device (not illustrated) such as a ROM, an HDD, a NV-RAM and an SD card installed in the server 110 and spread the program over a memory area of a RAM which provides a working area for a central processing unit (CPU) (not illustrated) of the server 200.

The request control unit 214 analyzes a message received from the network control unit 212, sorts requested processes into the response unit 228, the type-dependent driver generation controlling unit 216, the print control unit 222 or the associating information control unit 220. The request control unit 214 requests the network control unit 212 to send a message in response to requests from the functional units.

A request for a device searching message received from the client device 112 via the network 102 is sorted by the response unit 228. The response unit 228 returns a response message in order to make the client device recognize the server 110 as a virtual printer device. With the First Embodiment, the response message is sent as a response from the printer device. This means that device information of the printer device or the like is sent when the server responds to a message searching for the printer device. Specifically, in response to the device searching message in which a type of “i: PrintBasic” is designated, a response message (e.g. ProbeMatch message) is sent to the client device 112 by a unicast. In response to a GetMetadata action sent from the client device 112, device information (device ID, vendor ID, printer information or the like) or service information is sent. After receiving these messages, the client device 112 recognizes the server 110 as the virtual printer device conforming to the WSD. The response unit 228 of the First Embodiment may correspond to a response unit in the claims.

Acquiring requests for information for the installation (hereinafter, referred to as driver generation information acquiring request) are sorted to the type-dependent driver generation controlling unit 216. When the type-dependent driver generation controlling unit 216 receives the driver generation information acquiring request, the type-dependent driver generation controlling unit 216 calls a driver generation information reading unit 218 and the associating information control unit 220 to collect information for generating the printer driver peculiar to the type of the image forming apparatus 114 and corresponding to the client device 112 on the requestor side.

The associating information control unit 220 controls writing and reading of information to and from an associating information storing unit 232 for associating a client with an output destination (hereinafter, simply referred to as associating information storing unit). The associating information storing unit 232 is provided by the HDD, the NV-RAM or the like installed in the server 110. The associating information control unit 220 stores a table which statically associates the client device with the image forming apparatus at the output destination, reads the corresponding output destination and an identification value of the driver generation information of the output destination using the client identification value included in the acquiring request as a key, and returns the read corresponding output destination and identification value to the type-dependent driver generation controlling unit 216.

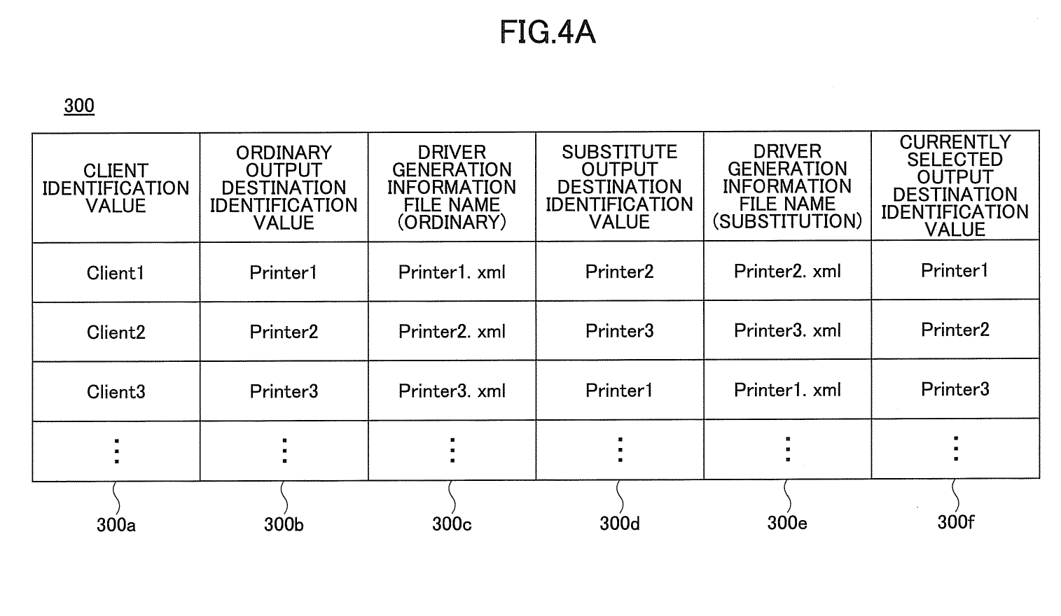

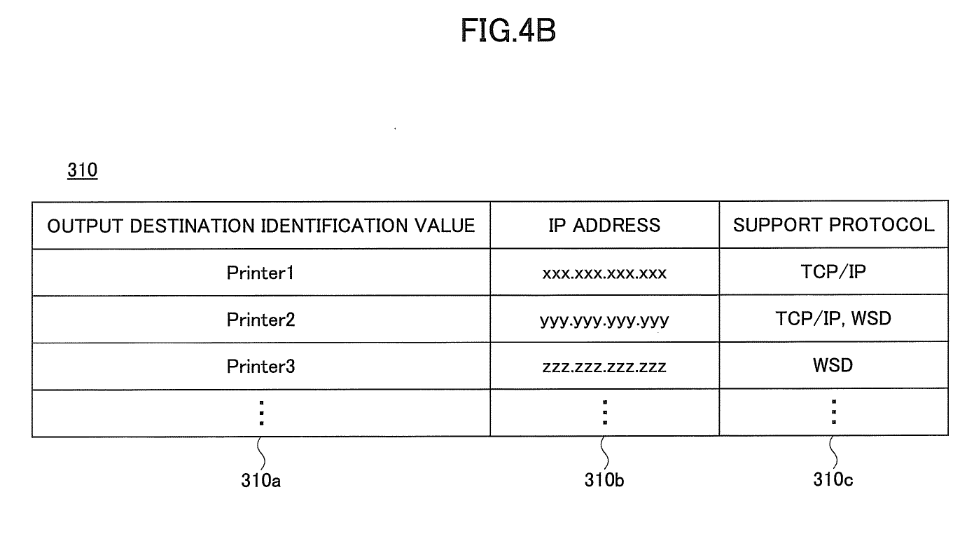

FIG. 4A illustrates the data structure of an output destination associating table which associates the client with the output destination stored in the associating information storing unit 232. Referring to FIG. 4A, the associating table 300 includes a client identification value 300a, an identification value 300b of an ordinary output destination used by the client device as default, a file name 300c of driver generation information at the output destination, an identification value 300d of a substitute output destination, a file name 300e of driver generation information at the substitute output destination, and an identification value 300f of a currently selected output destination, which are associated mutually. The currently selected output destination is either one of the ordinary output destination and the substitute output destination. The ordinary output destination is ordinarily selected, and the substitute output destination is selected when the image forming apparatus at the ordinary output destination may not used due to a failure or the like.

The client identification value is used for identifying the client device or the user. The client identification value may be an Internet Protocol (IP) address of the client device 112, a media access control (MAC) address, a computer name, a user name, an identification value to be independently allocated to the client device, or the like. With the First Embodiment, the file name of the driver generation information is used as the identification value of the driver generation information. As long as the driver generation information is specified and acquired, other identification information such as a pass name, a URL, and an independently allocated identification value may be used as the identification value of the driver generation information.

The association between the client device and the image forming apparatus may be determined by the static associating table illustrated in FIG. 4A or conditioned in response to the other information. For example, when positional information is acquired using a wireless LAN, it is possible to condition the output destination using the positional information or distribute the image forming apparatuses among the client devices when the number of the client devices associated with one of the image forming apparatuses at the output destination is large. The associating information control unit 220 of the First Embodiment may correspond to an associating information control unit in claims.

Referring back to FIG. 2, the driver generation information reading unit 218 accesses a driver generation information storing unit 230 which stores the driver generation information for each type of the image forming apparatuses. The driver generation information reading unit 218 reads driver generation information corresponding to an output destination using the file name of the driver generation information from the driver generation information storing unit 230 and returns the read driver generation information to the type-dependent driver generation controlling unit 216.

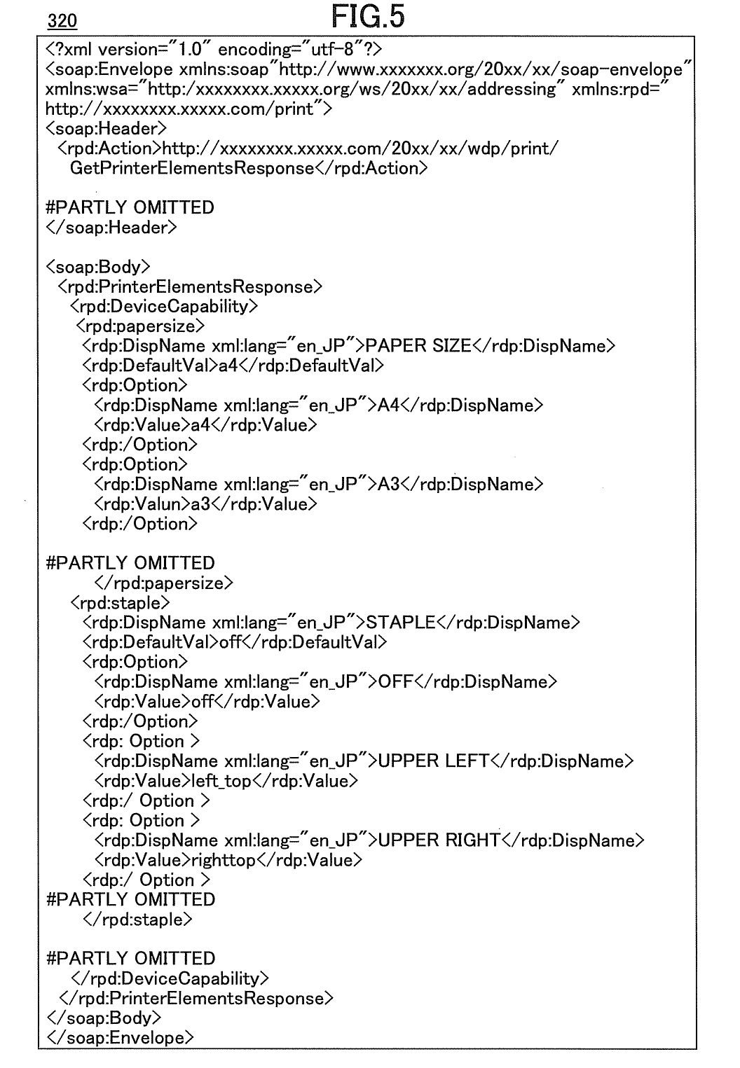

FIG. 5 illustrates a data structure of the driver generation information for each type of the image forming apparatus stored in the driver generation information storing unit 230 of the server 110 of the First Embodiment. Referring to FIG. 5, driver generation information 320 describes functional information of devices with an eXtensible Markup Language (XML).

Referring to FIG. 5, it is indicated that “A4” and “A3” are optionally selectable and “A4” is the default value. The options are represented by values indicative of the options. In the example illustrated in FIG. 5, the type includes a stapling function. With this stapling function, “off”, “upper left”, and “upper right” are selectable options and “off” is the default value. The driver generation information 320 is provided for each type of the image forming apparatus from a vendor or the like and previously prepared in the driver generation information storing unit 230 provided by the HDD, the NV-RAM or the like of the server 110. The driver generation information storing unit 230 of the First Embodiment may correspond to a storing unit in claims. Referring back to FIG. 2, the type-dependent driver generation controlling unit 216 acquires the driver generation information corresponding to the type of the image forming apparatus 114 at the output destination from the associating information control unit 220. Then, the type-dependent driver generation controlling unit 216 sends the driver generation information to the client device 112 on the requestor side via the request control unit 214 and the network control unit 212. When the client device 112 receives the driver generation information, the client device 112 generates a printer driver peculiar to the type of the image forming apparatus in conformity with the driver generation information. Thus, the installation is completed. The type-dependent driver generation controlling unit 216 of the First Embodiment may correspond to a driver generation controlling unit in claims.

Due to operation of the above functional unit, the printer driver peculiar to the type of the image forming apparatus 114 is installed in the client device 112. On the other hand, the print request from the client device 112 in which the printer driver peculiar to the type of the image forming apparatus 114 is installed is sorted into the print control unit 222. The print control unit 222 receives the print request and gives the client identification value included in the print request as a key upon receipt of the print request. Then, print control unit 222 calls the associating information control unit 220 and acquires an output destination identification value associated with the client device on the requestor side. The print control unit 222 gives the identification value of the output destination, calls a printer list searching unit 226, and acquires information for sending the print command to the image forming apparatus 114 at the output destination.

A printer list storing unit 234 is provided by the HDD, the NV-RAM or the like installed in the server 110. The printer list storing unit 234 stores a printer list which associates the image forming apparatus, its IF address, and its support protocol, reads the IF address and the support protocol using the output destination identification value as a key, and sends back the read IF address and support protocol to the printer list searching unit 226.

FIG. 4B illustrates a data structure of the printer list stored in the printer list storing unit 234 of the server 110 of the First Embodiment. Referring to FIG. 4B, a printer list 310 associates an identification value 310a, an IF address 310b, and a protocol 310c supported by the output destination. The printer list 310 may recognize devices by a plug and play function or a network expansion plug and play function. At this time, the printer list 310 is formed.

Referring back to FIG. 2, the print control unit 222 acquires a protocol supported by the output destination. When necessary, a format conversion unit 224 is called, a format conversion is provided to the print data, and a print command is sent to the image forming apparatus 114 at the output destination with the corresponding protocol via the request control unit 214 and the network control unit 212. Upon receipt of the print command, the image forming apparatus 114 processes the print data to form an image and outputs the formed image. The format conversion unit 224 appropriately carries out conversions of print setup data included in the print data and a page description language (PDL) included in core data of the print data. The print control unit 222 of the First Embodiment may correspond to a print control unit of the present invention, and the format conversion unit 224 of the First Embodiment may correspond to a conversion unit in claims.

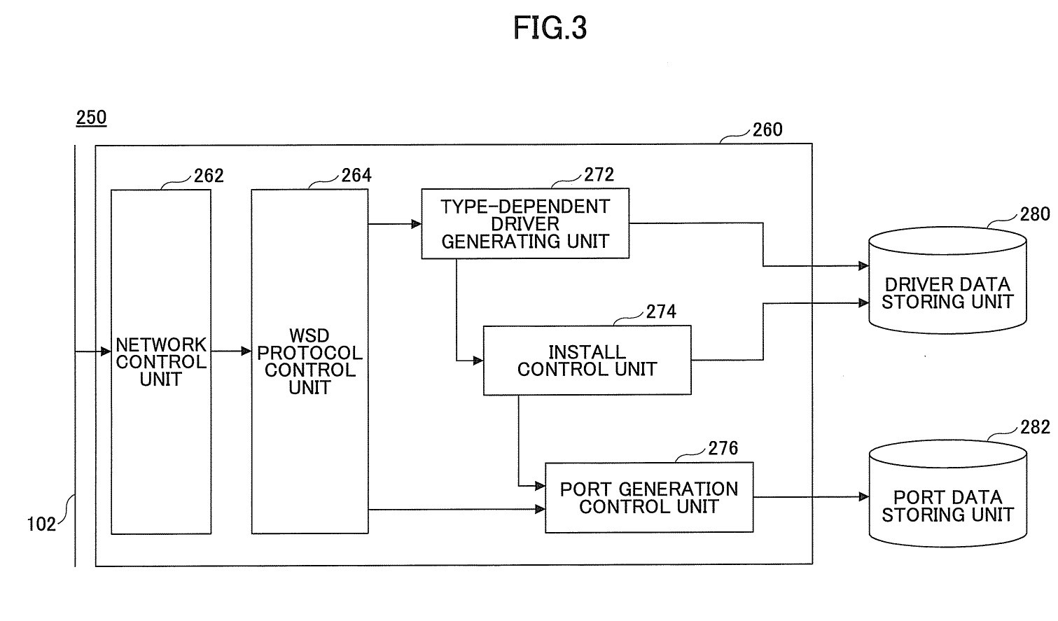

Next, the functional structure on the side of the client device 112 is described. FIG. 3 is a functional block diagram of the network printing system on the side of the server 112 of the First Embodiment. The functional block diagram 250 on the side of the client device 112 includes a network control unit 262 which controls to exchange packets with the network 102, a WSD protocol control unit 264, a type-dependent driver generating unit 272, an install control unit 274, and a port generation control unit 276. Only functional units related to the installation of the drivers are illustrated in FIG. 3.

Various functional units surrounded by a section 260 in FIG. 3 read out a program stored in a memory device (not illustrated) such as a ROM, an HDD, a flash memory and an SD card installed in the client device 112 and load the program in a memory area of a RAM which provides a working area for a central processing unit (CPU) (not illustrated) of the client device 112. A driver data storing unit 280 and a port data storing unit 282 illustrated in FIG. 3 are realized by a storage area of the HDD and the flash memory.

The WSD protocol control unit 264 carries out a device detecting process in accordance with the WSD protocol. More specifically, the WSD protocol control unit 264 sends a multicast with a device searching message (Probe message) to the network 102 via the network control unit 262 to detect the device on the network 102 and waits for a response message (ProbeMatch message). When a response to the device searching message is received, an existence of the device is detected, a device information request message (GetMetadata message) is sent with a unicast, the device configuration information and service information are acquired, and the device is recognized.

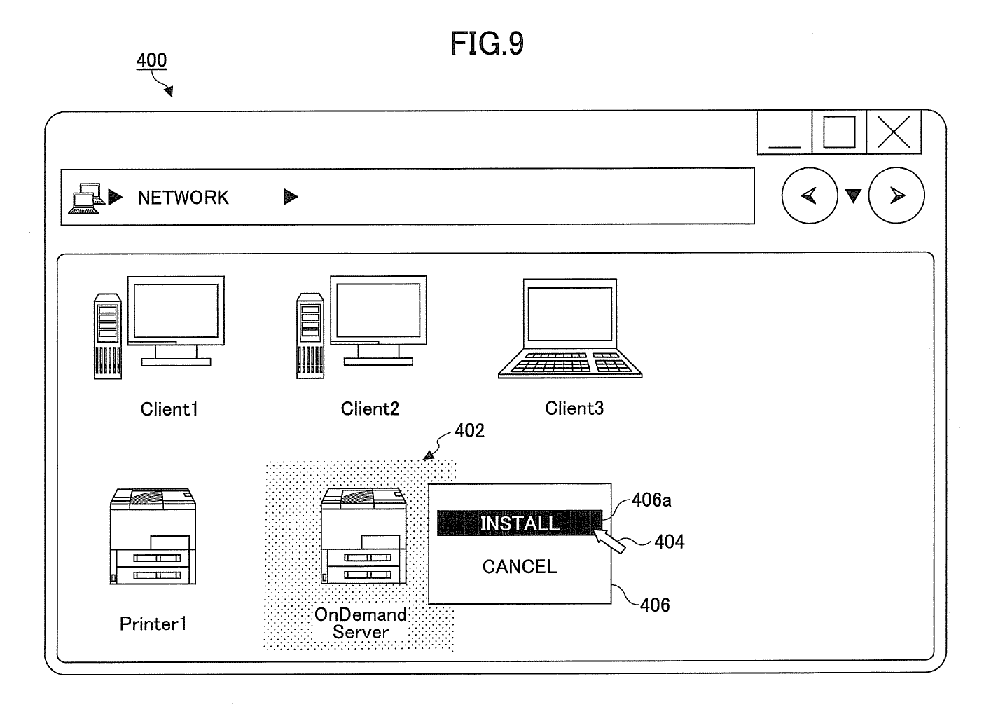

FIG. 9 is an example graphical user interface (hereinafter referred to as GUI) displayed on the display of the client device 112. When the server 110 is recognized in the network 102, an icon of the server 110 is displayed as a printer device on a screen 400 for displaying the network structure of the client device 112. For example, when the user of the client device 112 focuses and selects the icon 402 of the server 110 with the pointer 404 and selects an install 406a with a right click menu 406 or the like to carry out the installation, a process of installing a printer driver with a network extension plug and play such as Plug and Play eXtension (PnO-X) is started.

After starting the installation process of the driver, a printer driver of a common type (hereinafter, referred to as common format driver) which does not depend on the type of the image forming apparatus is first installed in response to the device information and the service information acquired from the server 110. Subsequently, the printer driver peculiar to the type of the image forming apparatus is configured through the communications with the server 110. Thus, the installation is completed. In the installation process, the type-dependent driver generating unit 272, the install control unit 274, and the port generation control unit 276 are associated with each other.

The port generation control unit 276 makes a printer port and stores port data defining the printer port into the port data storing unit 282. The type-dependent driver generating unit 272 sends a driver generation information acquiring request to the server 110 via the WSD protocol control unit 264 and the network control unit 262, and acquires printer generation information of the output destination associated with the client device 112 from the server 110. When the printer generation information is acquired, the install control unit 274 generates driver data defining the printer driver of a type dependent form, and stores the generated driver data into the driver data storing unit 280. The driver data describe a function performed by the image forming apparatus in a manner similar to the printer generation information. The driver data may be the same as the printer generation information or converted to a format by which the printer driver is easily processed.

The common format driver is provided as an installation package in common with a group of types supported by the network printing system 100. The common format driver is previously prepared on the client device 112. The common format driver acquires the driver generation information through the communications with the server 110 as described above, and has a function of generating the printer driver peculiar to the type of the image forming apparatus 114 in accordance with the information. As such, the common format driver is reconstructed to be the type-dependent driver by constructing the port data and the driver data in conformity with the information acquired from the server 110.

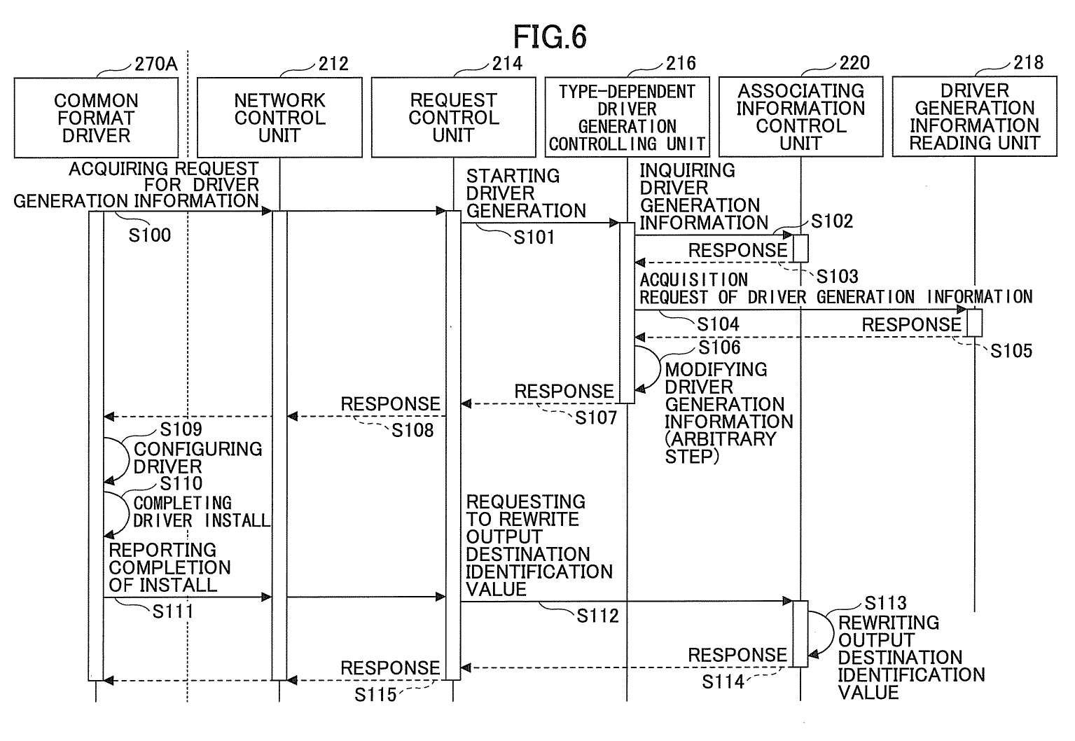

Referring to FIG. 6, a process of installing the type-dependent driver is described in detail. FIG. 6 is a sequence diagram for illustrating an installation process of the type-dependent driver in the network printing system of the First Embodiment. FIG. 6 illustrates a process on and after the common format driver is configured in the client device 112 in response to the user command.

In step S100, the common format driver 270A configured in the client device 112 sends an acquiring request for the driver generation information and a client identification value to the server 110. The acquiring request is sent to the request control unit 214 via the network control unit 212 of the server 110.

In step S101, the request control unit 214 sends the acquiring request to the type-dependent driver generation controlling unit 216 thereby causing the type-dependent driver generation controlling unit to start the type-dependent driver generation process. In step S102, the type-dependent driver generation controlling unit 216 gives a client identification value to the associating information control unit 220, and queries driver generation information of a currently selected output destination associated with the client identification value. In step S103, a file name of the driver generation information is acquired as the response.

In step S104, the type-dependent driver generation controlling unit 216 gives the file name to the driver generation information reading unit 218 and requests an acquisition of the driver generation information. In step S105, the driver generation information is acquired as a response to the acquisition request. In step S106, the type-dependent driver generation controlling unit 216 modifies the driver generation information being an arbitrary step. A process of modifying the driver generation information is described in detail later. In step S107, the type-dependent driver generation controlling unit 216 sends the driver generation information in response to the request control unit 214.

In step S108, the request control unit 214 sends the driver generation information to the client device 112 in response to the acquiring request of the driver generation information via the network control unit 212. In step S109, the common format driver 270A of the client device 112 generates the driver data of the type-dependent driver in conformity with the acquired driver generation information. In step S110, the installation process of the type-dependent driver is completed. In step S111, the common format driver 270A sends a report indicating that the installation process has been normally completed to the server 110. The report indicating that the installation process has been normally completed is sent to the request control unit 214 via the network control unit 212 of the server 110.

In step S112, the request control unit 214 sends a request to rewrite the currently selected output destination identification value to the associating information control unit 220 upon receipt of the report indicating that the installation process has been normally completed. In step S113, the associating information control unit 220 rewrites a value of the field 300f of a record of the client identification value of the associating table 300 and sends a response to the request control unit 214 in step S114. In step S115, the request control unit 214 responds to the report of the completion of the installation and finishes the process.

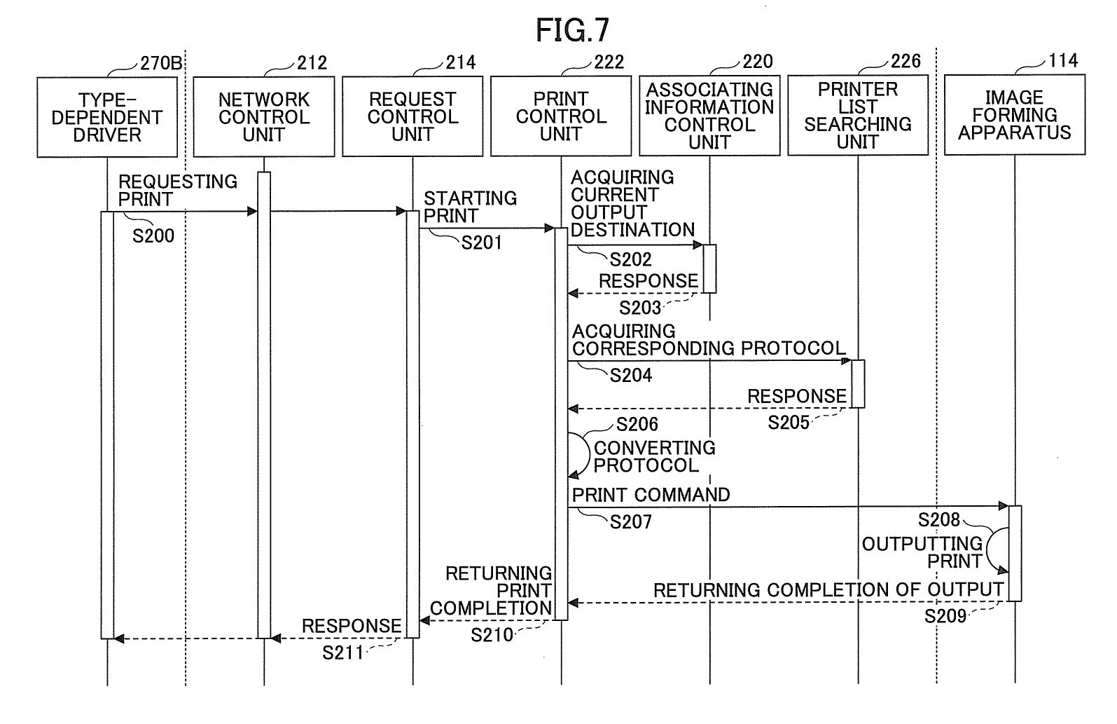

With the above sequence, the printer driver peculiar to the type of the image forming apparatus at the output destination is configured in the client device 112. Then, the image forming apparatus assumes a printable condition. Referring to FIG. 7, a print process of installing the type-dependent driver is described in detail. FIG. 7 is a sequence diagram for illustrating a print process using the type-dependent driver in the network printing system 100 of the First Embodiment.

Referring to FIG. 7, in step S200, the type-dependent driver 270B sends a print request to the server 110. The print request includes the client identification value and the print data including the print setup data and the core data. The print request is sent to the request control unit 214 via the network control unit 212 of the server 110. In step S201, the request control unit 214 sends the print request to the print control unit 222 and starts the print process related to the print request.

In step S202, the print control unit 222 gives a client identification value to the associating information control unit 220, and queries for the currently selected output destination associated with the client identification value. In step S203, the output destination identification value is acquired as the response. In step S204, the print control unit 222 gives the output destination identification value to the printer list searching unit 226 and queries for a protocol supported by the image forming apparatus corresponding to the output destination identification value. In step S205, the corresponding protocol is acquired as the response.

In step S206, the format conversion unit 224 is called and the protocol conversion process is appropriately applied to the print data. The server 110 is recognized as the printer device conforming to the WSD by the client device 112. Therefore, in step S206, when the output destination does not conform to the WSD, the format conversion unit 224 processes to convert the format to a protocol to which the output destination conforms.

In step S207, the print control unit 222 sends a print command to the image forming apparatus 114 at the output destination along with the print data related to the print request. In step S208, the image forming apparatus 114 which receives the print command carries out the print output of the print data. In step S209, a report of completing the printing is returned to the server 110.

In step S210, the print control unit 222 receives a report that the printing is completed from the image forming apparatus 114, and returns the print completion report to the request control unit 214. In step S211, the request control unit 214 returns an issue that the print output for the print request is completed to the type-dependent driver 270B. Then, the process is completed.

Referring to FIG. 7, only the completion report from the image forming apparatus has been returned to the client device. However, it is possible to have a structure where a job processing state in the image forming apparatus 114 is reported to the client device 112 via the server 110, and the job processing state may be checked by the client device 112.

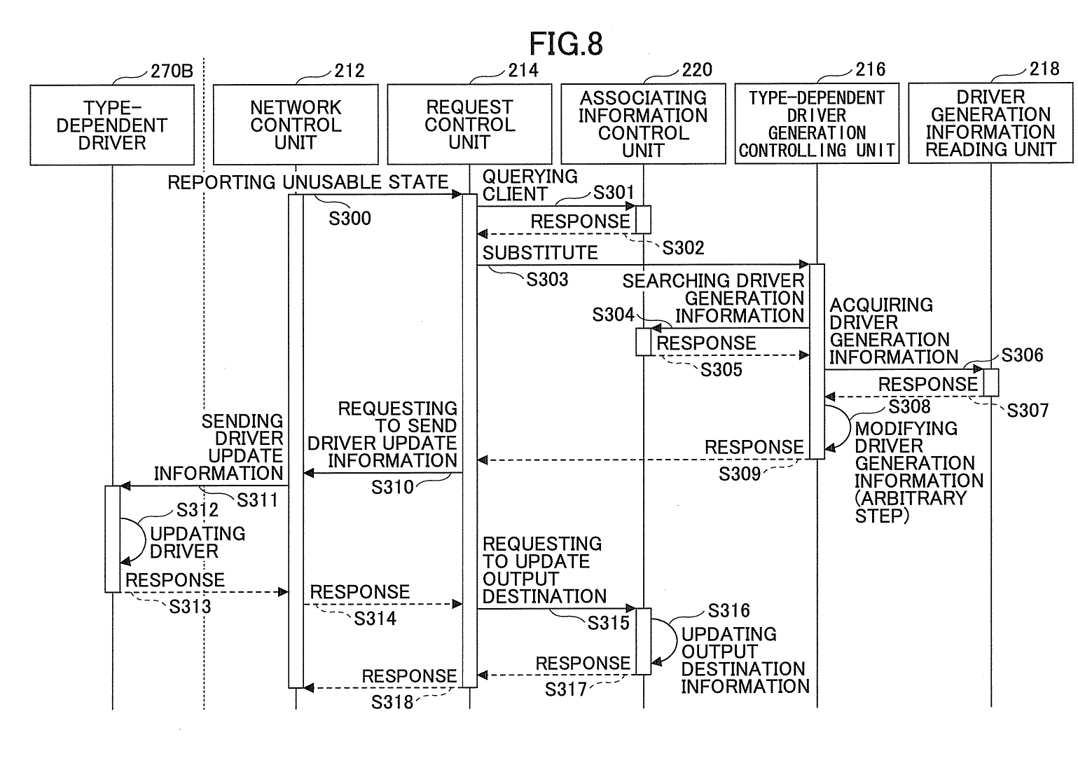

With the above sequence, the client device 112 is associated with the image forming apparatus 114 at the output destination. On the side of the client device 112, it becomes possible to output the print request to the corresponding image forming apparatus 114 via the server 110. By adopting this structure enabling the print request via the server 110, the network printing system 100 can reconstruct the corresponding relationships while flexibly dealing with the environmental change. Referring to FIG. 8, a type-dependent driver update process which is carried out when the image forming apparatus 114 at the output destination currently used by the client device 112 become unusable.

FIG. 8 is a sequence diagram for illustrating an update process of the type-dependent driver in the network printing system 100 of the First Embodiment. In step S300, the network control unit 212 receives a report indicating that the image forming apparatus 114 becomes unusable and sends the report to the request control unit 214. The image processing apparatus 114 may become unusable when the image forming apparatus 114 is offline or becomes unusable due to an error. It may be detected by periodically polling from the server 110 or by querying from an operator whether the image forming apparatus is usable.

In step S301, the request control unit 214 receives the report indicating that the output destination is unusable, gives the output destination identification value, and queries the client device 112 currently using the output destination which becomes unusable to the associating information control unit 220. In step S302, a list of the client identification values is acquired as the response. Referring to FIG. 8, a case where the client device uses the unusable output destination is described.

In step S303, the request control unit 214 gives the client identification value and makes the type-dependent driver generation controlling unit 216 start a substitute driver generation process. In step S304, the type-dependent driver generation controlling unit 216 gives a client identification value to the associating information control unit 220, and queries driver generation information of the substitute output destination associated with the client identification value. In step S305, a file name of the driver generation information is acquired as the response.

In step S306, the type-dependent driver generation controlling unit 216 gives the file name to the driver generation information reading unit 218 and requests an acquisition of the driver generation information. In step S307, the driver generation information is acquired as a response to the acquisition request. In step S308, the type-dependent driver generation controlling unit 216 modifies the driver generation information as an arbitrary step. In step S309, the driver generation information is sent to the request control unit 214 as a response.

In step S310, the request control unit 214 requests the network control unit 212 to send the driver update information corresponding to the client identification value to the client device 112. In step S311, the network control unit 212 sends the driver update information to the client device 112. The driver update information is sent to the type-dependent driver of the client device 112 via the network 102. In step S312, the driver update information is received by the type-dependent driver 270B. The type-dependent driver 270B updates the driver data inside the driver data storing unit 280 in conformity with the received driver update information. In step S313, the completion of the update is returned to the server 110.

In step S314, the network control unit 212 returns the completion of the update to the request control unit 214. In step S315, the request control unit 214 receives the response of the completion of the update, gives the client identification value and the output destination identification value to the associating information control unit 220, and requests to rewrite the currently selected output destination identification value. In step S316, the associating information control unit 220 rewrites a value of the field 300f of a record of the client identification value of the associating table 300 and sends a response to the request control unit 214 in step S317. In step S318, the request control unit 214 responds to the network control unit and finishes the process.

When plural clients devices 112 using the unusable output destination are detected, the processes of steps S303 to S318 may be carried out for each of the detected plural client devices 112. The request control unit 214 of the First Embodiment may correspond to a driver update commanding unit in claims.

With the network printing system 100 of the First Embodiment, the type-dependent driver is configured on the side of the client device 112 by acquiring the driver generation information from the server 110. Therefore, it is possible to use the image forming apparatus 114 by holding only the driver package common to the plural types of the image forming apparatuses 114. Therefore, the client device 112 may not previously hold various installation packages of drivers for various types to be used. Further, the network printing system 100 may include image forming apparatuses 114 conforming to the WSD or not conforming to the WSD.

Further, the image forming apparatus at the output destination becomes usable on the side of the client device by instructing the installation in the server detected as the printer device. Therefore, the user can be released from a burden of selecting a desirable printer icon from many printer icons displayed on the network folder or the like. Even if the image forming apparatus is removed or replaced or becomes unusable, the driver data can be updated in response to the environmental change. Therefore, the burden of uninstallation and installation for users can be relaxed. It becomes possible to administer the image forming apparatus to be used as a standard or a substitute apparatus for the client devices on the administrator's side.

As described, since the print request is processed via the server 110 in the network printing system 100 of the First Embodiment, it is possible to limit functions of the type-dependent drivers to be provided to the client devices for each client device, or dynamically change print processes for each print request requested from the client devices.

### Second Embodiment

A network printing system of a Second Embodiment is described. The network printing system of the Second Embodiment may flexibly control functional limitations of a type-dependent driver provided to a client device and print processes in response to print requests.

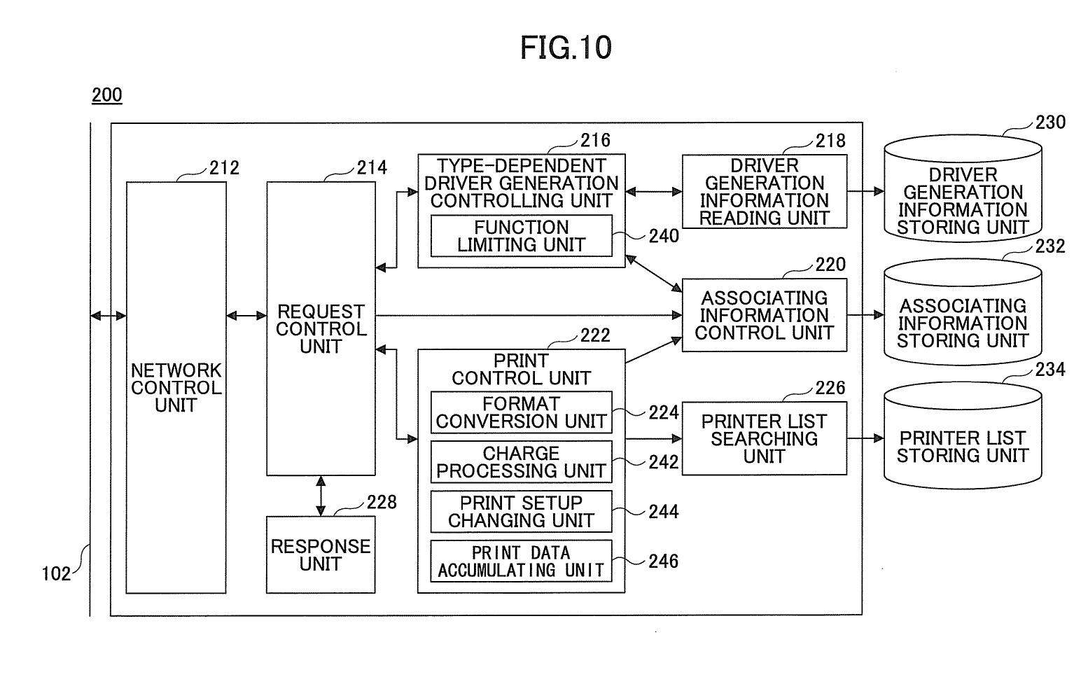

FIG. 10 schematically illustrates a network printing system 100 of the Second Embodiment. The same reference symbols are attached to portions similar to those of the First Embodiment, and description of these portions is omitted.

In a functional block diagram 200 on a side of a server 110, a type-dependent driver generation controlling unit 216 includes a function limiting unit 240. The function limiting unit 240 carries out an arbitrary process of the sequence illustrated in FIG. 6 and step S308 of the sequence illustrated in FIG. 8. A function limiting unit of the Second Embodiment may correspond to a function limiting unit in claims. A print control unit 222 of the Second Embodiment is configured by including a charge processing unit 242, and a print setup changing unit 244, a print data accumulating unit 246 in addition to a format conversion unit 224 illustrated in FIG. 2. These functional units carry out arbitrary processes in addition to the process of step S206 of the sequence illustrated in FIG. 7. The charge processing unit 242 of Second Embodiment may correspond to a charge processing unit in claims. The print setup changing unit 244 of the Second Embodiment may correspond to a print setup changing unit in claims. A print data accumulating unit 246 of the Second Embodiment may correspond to an accumulating unit in claims.

The function limiting unit 240 carries out a process related to limitation of functions of the type-dependent drivers for each of the above described client devices 112. The charge processing unit 242 records charge information in order to charge for processing of the print request for each client device 112. The charge information may be printed page numbers, paper numbers, printing modes, charged amounts or the like for each client or each user. These data are aggregated and used in charging each client device 112 or each user. The charge processing unit 242 stops a print process of print data when a charged amount to the client device 112 of the sending source exceeds a threshold value. This event may be reported to the client device 112 of the sending source.

The print setup changing unit 244 forcibly dynamically changes a print setup of print data requested to be printed in response to the client devices, contents of print, or the like. When the print setup of the print data is forcibly changed, the print setup changing unit 244 may be configured to report to the client device 112 of the sending source. The print data accumulating unit 246 accumulates the print data requested to be printed in outer and inner storages. Thereafter, an accumulating process enabling downloading the print data is carried out later from an outer personal computer or the like. In the accumulating process, the print data accumulating unit 246 gives an identification value to the print data and stores the print data in the outer or inner storage in association with the identification value.

In order to limit the functions of the type-dependent driver and control the dynamic change of the print setup, an associating information storing unit 232 of the Second Embodiment stores a group managing table for grouping the client devices and a function limitation managing table for defining the function limitation for each group in addition to an associating table for associating the client devices 112 with the image forming apparatuses 114. The group may be determined for each department in an organization, each user group, or each duty position.

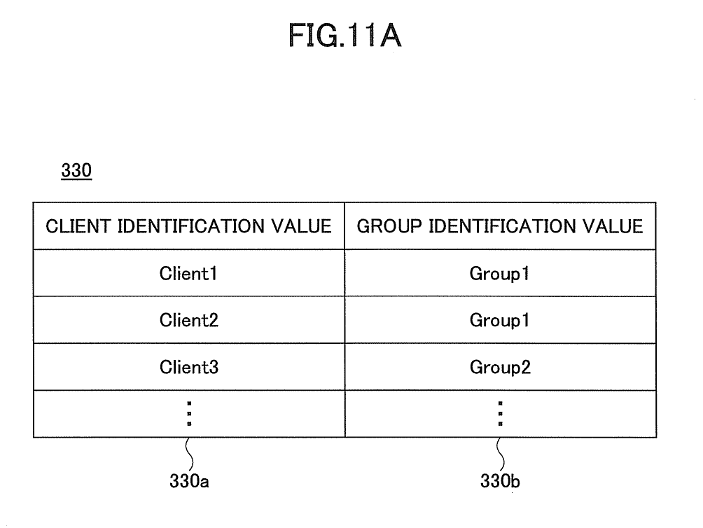

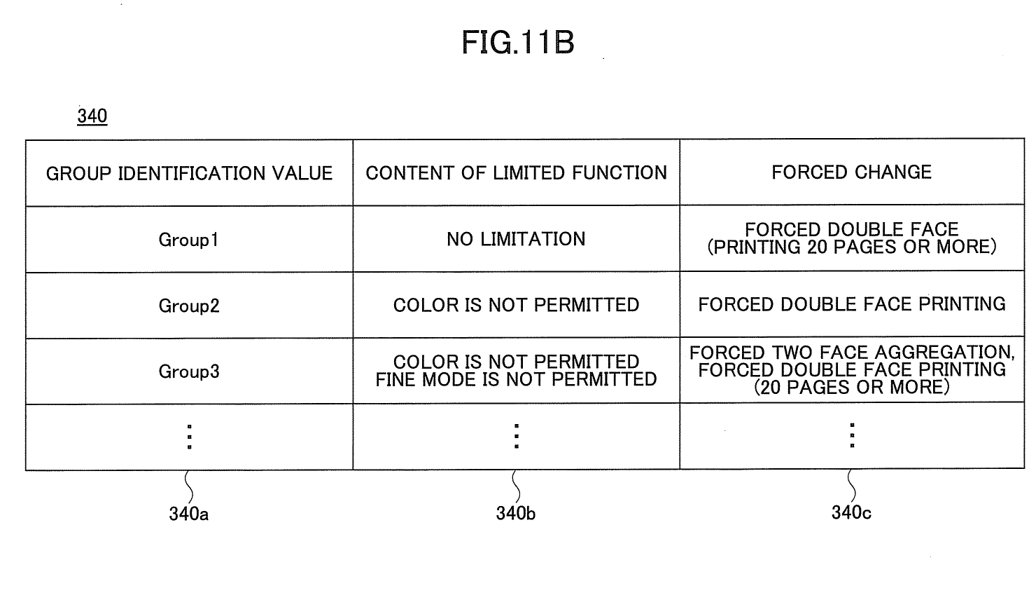

FIG. 11A illustrates a data structure of the group managing table 330 which divides the clients devices 112 into groups. FIG. 11B illustrates a data structure of a function limitation managing table which defines contents of the function limitations for each group. Referring to FIG. 11A, the group managing table 330 associates client identification values 330a with the group identification values 330b. The function limitation managing table 340 associates the group identification value 340a, contents of limited function 340b, and contents of forced change 340c.

The content of limited function 340b may include items such as “color is not permitted” and “fine mode is not permitted”. In accordance with the content of limited function 340b, the function limiting unit 240 modifies the driver generation information sent to the client devices in, for example, step S106 illustrated in FIG. 6. In case of “color is not permitted”, even if the image forming apparatus 114 can print color documents, the driver generation information may be modified to be a state in which an option of the color mode is deleted and the modified driver generation information may be sent to the client device belonging to the group subjected to the limitation of the function.

The content of the forced change 340c may include contents of forced changes of the print setup such as “forced double face printing (20 pages or more)” and “forced two face aggregation”. In accordance with the contents of the forced change 340c, the print setup changing unit 244 may rewrite print setup data before the format is converted in step S206 illustrated in FIG. 7. Referring to FIG. 11B, it is possible to condition application of the forced change using the print page number such as “20 pages or more” or the like.

The contents of the limited function and the forced change are a limitation or a forced change to the double face printing, a limitation or a forced change to a B&W mode, a limitation or a forced change to a background pattern, a limitation or a forced change to a stamp, a limitation or a forced change to a digital watermark, a limitation or a forced change to an aggregation printing having a predetermined layout, or the like.

As an example of the limitation or the forced change of the print setup, an administrator user is allowed to perform printing and an ordinary user is subjected to the limitation or forced change. When printing in color mode is designated and there is a predetermined number of pages or more, aggregation printing of “2 in 1” is carried out. Further, if the number of pages still exceeds the predetermined number of pages, aggregation printing of “4 in 1” is forcibly carried out instead.

With the network printing system 100 of the Second Embodiment, the type-dependent driver provided to the client device 112 may be subjected to the function limitation or the print process may be dynamically changed for each print request requested by the client device 112. Further, it is possible to integrally administer these setups with the server 110. Therefore, it is useful from an administrator's point of view.

As described, the First and Second Embodiments may provide a novel and useful server, which can reduce a burden of installing various printer drivers corresponding to types of the image forming apparatuses into client devices as much as possible even under an environment in which various image forming apparatuses which conform to or do not conform to a predetermined device recognition protocol exist, and enable effective administration of uses of the image forming apparatuses by an administrator; a printing system including the server; an image forming apparatus which receives a print command from a printer driver provided by the server and prints; and a recording medium storing a program causing a computer to function as the server.

The above mentioned functions may be realized by a program executed by a computer written in a legacy programming language or an object-oriented programming language such as an assembler, C language, C++ language, C# language, or Java (Java is a registered trademark), stored in a readable recording medium such as a ROM, an EEPROM, an EPROM, a flash memory, a flexible disk, a CD-ROM, a CD-RW, a DVD, an SD card, and an MO, and distributed.

According to the First and Second Embodiments, the driver generation information is acquired from the server by a client device and the corresponding driver is configured on the side of the client device. Therefore, the client device can print with an image forming apparatus by holding only a driver package common to plural types of image forming apparatuses. Therefore, the client device may not previously hold various installation packages of drivers for various types to be used. Further, since the server acts as the image forming apparatus, a print request is processed via the server. Therefore, it is possible to add image forming apparatuses conforming to a predetermined protocol and not conforming to the predetermined protocol to the print system.

Further, an image forming apparatus at an output destination becomes usable by the client device by performing an installation in the server 110 detected as the image forming apparatus. Therefore, the user can be released from a burden of selecting a desirable printer icon from many printer icons displayed on a network folder or the like.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiment of the present invention has been described in detail, it should be understood that various changes, substitutions, and alterations could be made thereto without departing from the spirit and scope of the invention.

This patent application is based on Japanese Priority Patent Application No. 2009-264593 filed on Nov. 20, 2009, the entire contents of which are hereby incorporated herein by reference.

What is claimed is:

1. A server connected to one or more client devices via a network, the server comprising:
a response unit configured to respond as an image forming apparatus to a device searching message sent from the one or more client devices;
an associating information control unit configured to associate the one or more client devices with the image forming apparatus;
a storing unit configured to store driver generation information which enables generation of a driver corresponding to the image forming apparatus on a side of the one or more client devices;
a driver generation controlling unit configured to respond to a driver generation information acquiring request from the one or more client devices and send the driver generation information corresponding to the image forming apparatus associated with the one or more client devices to the one or more client devices; and
a print control unit configured to respond to a print request received from the driver generated by the one or more client devices and send print data corresponding to the print request to the image forming apparatus associated with the one or more client devices in response to the print request received from the driver generated by the one or more client devices and cause the print data to be printed with the image forming apparatus.

2. The server according to claim 1,
wherein the number of the image forming apparatuses is plural, and
the associating information control unit associates the plurality of image forming apparatuses with the one or more client devices,
the server further comprising:
a driver update commanding unit configured to, when any one of the image forming apparatuses becomes unusable, send the driver generation information of another usable image forming apparatus to the one or more client devices associated with the unusable one of the image forming apparatuses which is an output destination of the one or more client devices and command updating of the driver.

3. The server according to claim 1,
wherein the print control unit includes a print setup changing unit configured to forcibly change a print setup of the print request in conformity with the one or more client devices which are a sending source of the print request.

4. The server according to claim 1,
wherein the driver generation controlling unit includes a function limiting unit configured to modify the driver generation information corresponding to the one or more client devices which send the driver generation information acquiring request to limit usable functions in conformity with the client device.

5. The server according to claim 1,
wherein the print control unit analyzes print data of the print request and records charge information for a user.

6. The server according to claim 1,
wherein the print control unit includes a conversion unit configured to convert a format of the print data of the print request in conformity with a protocol supported by the image forming apparatus associated with the one or more client devices of the sending source of the print request.

7. The server according to claim 1,
wherein the print control unit includes an accumulating unit configured to accumulate the print data of the print request inside or outside the accumulating unit and send the accumulated print data to the image forming apparatus in response to a download request from the image forming apparatus.

8. The server according to claim 3,
wherein the print setup changing unit reports the change when the print setup of the print data is forcibly changed to the one or more client devices of the sending source of the print request.

9. The server according to claim 5,
wherein the charge processing unit stops the print process of the print data and reports the stop to a certain one of the one or more clients devices when a charge amount on the certain one of the one or more client devices of the sending source of the print request exceeds a threshold.

10. A print system comprising:
a server;
a network; and
one or more client devices connected to the server via the network,
wherein the server includes
a response unit configured to respond as an image forming apparatus to a device searching message sent from the one or more client devices;
an associating information control unit configured to associate the one or more client devices with the image forming apparatus;
a storing unit configured to store driver generation information which enables generation of a driver corresponding to the image forming apparatus on a side of the one or more client devices;
a driver generation controlling unit configured to respond to a driver generation information acquiring request from the one or more client devices and send the driver generation information corresponding to the image forming apparatus associated with the one or more client devices to the one or more client devices; and
a print control unit configured to respond to a print request received from the driver generated by the one or more client devices and send print data corresponding to the print request to the image forming apparatus associated with the one or more client devices in response to the print request received from the driver generated by the one or more client devices and cause the print data to be printed with the image forming apparatus.

11. The print system according to claim 10,
wherein the number of the image forming apparatuses is plural, and
the associating information control unit associates the plurality of image forming apparatuses with the one or more client devices,
the server further comprising:
a driver update commanding unit configured to, when any one of the image forming apparatuses becomes unusable, send the driver generation information of another usable image forming apparatus to the one or more client devices associated with the unusable one of the image forming apparatuses which is an output destination of the one or more client devices and command updating of the driver.

12. The print system according to claim 10,
wherein the print control unit includes a print setup changing unit configured to forcibly change a print setup of the print request in conformity with the one or more client devices which are a sending source of the print request.

13. The print system according to claim 10,
wherein the driver generation controlling unit includes a function limiting unit configured to modify the driver generation information corresponding to the one or more client devices which send the driver generation information acquiring request to limit usable functions in conformity with the client device.

14. The print system according to claim 10,
wherein the print control unit analyzes print data of the print request and records charge information for a user.

15. The print system according to claim 10,
wherein the print control unit includes a conversion unit configured to convert a format of the print data of the print request in conformity with a protocol supported by the image forming apparatus associated with the one or more client devices of the sending source of the print request.

16. The print system according to claim 10,
wherein the print control unit includes an accumulating unit configured to accumulate the print data of the print request inside or outside the accumulating unit and send the accumulated print data to the image forming apparatus in response to a download request from the image forming apparatus.

17. The print system according to claim 12,
wherein the print setup changing unit reports the change when the print setup of the print data is forcibly changed to the one or more client devices of the sending source of the print request.

18. The print system according to claim 14,
wherein the charge processing unit stops the print process of the print data and reports the stop to a certain one of the one or more clients devices when a charge amount on the certain one of the one or more client devices of the sending source of the print request exceeds a threshold.

19. A non-transitory computer-readable storage medium storing a program for causing a computer of a server connected to one or more client devices via a network to function as:
a response unit configured to respond as an image forming apparatus to a device searching message sent from the one or more client devices;
an associating information control unit configured to associate the one or more client devices with the image forming apparatus;
a storing unit configured to store driver generation information which enables generation of a driver corresponding to the image forming apparatus on a side of the one or more client devices;
a driver generation controlling unit configured to respond to a driver generation information acquiring request from the one or more client devices and send the driver generation information corresponding to the image forming apparatus associated with the one or more client devices to the one or more client devices; and
a print control unit configured to respond to a print request received from the driver generated by the one or more client devices and send print data corresponding to the print request to the image forming apparatus associated with the one or more client devices in response to the print request received from the driver generated by the one or more client devices and cause the print data print to be printed with the image forming apparatus.

20. The non transitory computer-readable storage medium according to claim 19,
wherein the number of the image forming apparatuses is plural, and
the associating information control unit associates the plurality of image forming apparatuses with the one or more client devices,
the server further comprising:
a driver update commanding unit configured to, when any one of the image forming apparatuses becomes unusable, send the driver generation information of another usable image forming apparatus to the one or more client devices associated with the unusable one of the image forming apparatuses which is an output destination of the one or more client devices and command updating of the driver.
